(19) United States
(12) Patent Application Publication
(10) Pub. No.: US 2006/0170319 A1
(43) Pub. Date: Aug. 3, 2006

(54) Backlight device and liquid crystal display device

(76) Inventors: Takashi Oku, Saitama (JP); Yoshinori Yamazaki, Saitama (JP); Tsuneo Kusunoki, Kanagawa (JP); Katsutoshi Ohno, Tokyo (JP); Takahiro Igarashi, Kanagawa (JP)

Correspondence Address: William E. Vaughan;Bell, Boyd & Lloyd LLC, P.O. Box 1135, Chicago, IL, 60690, US

(21) Appl. No.: 11/330,506

(22) Filed: Jan. 12, 2006

(30) Foreign Application Priority Data
Jan. 14, 2005 (JP) P2005-008271

(51) Int. Cl. H01K 1/30; H01K 1/26

(52) U.S. Cl. 313/116

(57) ABSTRACT

A backlight device is provided that realizes high luminance while widening the color range. The backlight device illuminates a transmissive color liquid crystal display panel with white light from a back side of the transmissive color liquid crystal display panel having a color filter made of a three-primary-color filter which selectively transmits light having wavelengths of red light, green light, and blue light. The backlight device includes a plurality of cold cathode fluorescent lamp tubes having tube walls coated with a wide-color-range fluorescent material. The backlight device also includes a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes. A predetermined pattern is printed on the diffusion plate, by dot printing, corresponding to positions at which the cold cathode fluorescent lamp tubes are provided, and the diffusion plate is positioned several mm apart from the cold cathode fluorescent lamp tubes.

### CROSS REFERENCES TO RELATED APPLICATIONS

The present application claims priority to Japanese Patent Application JP 2005-008271 filed in the Japanese Patent Office on Jan. 14, 2005, the entire contents of which being incorporated herein by reference.

### BACKGROUND

The present invention generally relates to a backlight device which is included in a liquid crystal display device or the like to expand the color range of the display device. The present disclosure also relates to the liquid crystal display device including the backlight device.

Compared with cathode ray tubes (CRTs), liquid crystal display devices are advantageous in that they can have a larger display screen, a lighter weight, a thinner depth, a low power consumption, etc. Hence, liquid crystal display devices as well as PDPs (Plasma Display Panels) of a self-light-emission type have come to be used in television receivers, various displays, and the like. In a liquid crystal display device, liquid crystal is sealed between two transparent substrates which may be of various sizes. A voltage is applied between the substrates to vary orientations of liquid crystal molecules. Thus, light transmission rates are varied to optically display predetermined images and the like.

In a liquid crystal display device, for example, a backlight unit which functions as a light source is provided at a back part of a liquid crystal panel because liquid crystal itself is not a light emission element. The backlight unit has, for example, a primary light source, a light guide plate, a reflection film, a lens sheet, a diffusion film, and the like, and supplies display light over the entire face of the liquid crystal panel. The backlight unit uses a cold cathode fluorescent lamp (CCFL) in which Hg (mercury) or Xe (xenon) is sealed in a fluorescent lamp tube.

Meanwhile, in standard display devices, the color range is defined according to the sRGB (a color space according to IEC) standard. However, there still are many colors that exceed the color range according to the sRGB standard. Some object colors cannot be displayed by display devices according to the sRGB standard. For example, films, digital cameras, and printers have already been beyond the ranges according to the sRGB. See, JP Pat. Appn. Laid-Open Publication No. 2004-172011.

Hence, a display device which covers a wider color range than the sRGB is demanded at present. In order to respond to widening of the color range, sYCC having a wider color range has been defined as an industry standard.

On the other hand, NTSC (National Television System Committee) has been adopted as a color-TV broadcasting system. The NTSC uses a larger band width than the sRGB. In order to put the sYCC to practical use, a color range equal to or beyond the NTSC color range needs to be realized on the display screen.

Recently, display devices have become thinner as represented by liquid crystal TV and PDP. Many of those display devices adopt a liquid crystal system for which accurate color reproducibility has been demanded.

Widening of a color range depends on wavelengths of fluorescent materials of respective colors used by a CCFL as a light source used for a backlight. Although widening of a color range can be achieved by choosing appropriate ones for the fluorescent materials, luminance deteriorates.

### SUMMARY

In view of the aspects described above, a backlight device is provided that can widen the color range of a liquid crystal display device, minmally reducing the luminance value, and a liquid crystal display device is provided having the backlight device.

In accordance with one embodiment, there is provided a backlight device that illuminates a transmissive color liquid crystal display panel with white light from a back side of the transmissive color liquid crystal display panel having a color filter made of a three-primary-color filter which selectively transmits light having wavelengths of red light, green light, and blue light, the backlight device including: a plurality of cold cathode fluorescent lamp tubes having tube walls coated with a wide-color-range fluorescent material; and a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes, wherein a predetermined pattern is printed on the diffusion plate, by dot printing, corresponding to positions at which the cold cathode fluorescent lamp tubes are provided, and the diffusion plate is positioned several mm apart from the cold cathode fluorescent lamp tubes.

In an embodiment, the tube walls of the cold cathode fluorescent lamp tubes may be coated with BaMgAl₁₀O₁₇:Eu as a blue fluorescent material, BaMgAl₁₀O₁₇:Eu, Mn as a green fluorescent material, and YVO₄:Eu as a red fluorescent material.

In an embodiment, a backlight device according to the present invention illuminates a transmissive color liquid crystal display panel with white light from a back side of the transmissive color liquid crystal display panel having a color filter made of a three-primary-color filter which selectively transmits light having wavelengths of red light, green light, and blue light, the backlight device including: a plurality of cold cathode fluorescent lamp tubes having tube walls coated with a wide-color-range fluorescent material; and a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes, wherein the cold cathode fluorescent lamp tubes have an inner diameter which is determined by or based on a lifetime of the cold cathode fluorescent lamp tubes, and by luminance of the white light emitted from the cold cathode fluorescent lamp tubes.

In an embodiment, the tube walls of the cold cathode fluorescent lamp tubes may be coated with BaMgAl₁₀O₁₇:Eu as a blue fluorescent material, BaMgAl₁₀O₁₇:Eu, Mn as a green fluorescent material, and YVO₄:Eu as a red fluorescent material.

In an embodiment, the inner diameter of the cold cathode fluorescent lamp tubes may be about 1.8 mm.

In an embodiment, a liquid crystal display device has a backlight device which illuminates a transmissive color liquid crystal display panel with white light from a back side of the transmissive color liquid crystal display panel having a color filter made of a three-primary-color filter which selectively transmits light having wavelengths of red light, green light, and blue light, the backlight device including: a plurality of cold cathode fluorescent lamp tubes having tube walls coated with a wide-color-range fluorescent material; and a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes, wherein a predetermined pattern is printed on the diffusion plate, by dot printing, corresponding to positions at which the cold cathode fluorescent lamp tubes are provided, and the diffusion plate is positioned several mm apart from the cold cathode fluorescent lamp tubes.

In an embodiment, the tube walls of the cold cathode fluorescent lamp tubes may be coated with BaMgAl₁₀O₁₇:Eu as a blue fluorescent material, BaMgAl₁₀O₁₇:Eu,Mn as a green fluorescent material, and YVO₄:Eu as a red fluorescent material.

In an embodiment, a liquid crystal display device has a backlight device which illuminates a transmissive color liquid crystal display panel with white light from a back side of the transmissive color liquid crystal display panel having a color filter made of a three-primary-color filter which selectively transmits light having wavelengths of red light, green light, and blue light, the backlight device including: a plurality of cold cathode fluorescent lamp tubes having tube walls coated with a wide-color-range fluorescent material; and a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes, wherein the cold cathode fluorescent lamp tubes have an inner diameter which is determined by or based on a lifetime of the cold cathode fluorescent lamp tubes, and by luminance of the white light emitted from the cold cathode fluorescent lamp tubes.

In an embodiment, the tube walls of the cold cathode fluorescent lamp tubes may be coated with BaMgAl₁₀O₁₇:Eu as a blue fluorescent material, BaMgAl₁₀O₁₇:Eu,Mn as a green fluorescent material, and YVO₄:Eu as a red fluorescent material.

The inner diameter of the cold cathode fluorescent lamp tubes may be about 1.8 mm.

In an embodiment, the backlight device is constituted by the fluorescent lamp tubes whose tube walls are coated with the fluorescent material for a wide color range, and the diffusion plate positioned at a predetermined distance from the fluorescent lamp tubes. The backlight device illuminates the transmissive color liquid crystal display panel which displays predetermined video images by means of liquid crystal molecules, with white light from the back side of the panel. Therefore, the color range can be widened. In addition, the distance between the fluorescent lamp tubes and the diffusion plate is set to ten several mm. As a result, high luminance can be maintained without causing irregularity in luminance. Further, the distance between the fluorescent lamp tubes and the diffusion plate can be reduced to several mm, by printing the predetermined dot pattern on the diffusion plate, so that the tubes and the plate can be closer to each other. Thus, the whole device can be thinned. Alternatively, high luminance can be maintained by downsizing the inner diameter Ø of the fluorescent lamp tubes to an inner diameter Ø which is determined by the luminance and lifetime of the fluorescent lamp tubes.

Additional features and advantages are described herein, and will be apparent from, the following Detailed Description and the figures.

### BRIEF DESCRIPTION OF THE FIGURES

FIG. 1 is an exploded perspective view illustrating a transmissive liquid crystal display panel according to an embodiment of the present invention;

FIG. 2 is an explanatory view for a color filter;

FIG. 3 is a graph showing spectral characteristics of the color filter;

FIG. 4A is a front view of a backlight box using fluorescent lamp tubes as light sources and FIG. 4B is a cross-sectional view thereof;

FIG. 5 is a view for describing principles of the fluorescent lamp tube;

FIG. 6 is a graph comparing the chroma reproducibility rate of fluorescent lamp tubes coated with a conventional fluorescent material and the chroma reproducibility rate of fluorescent lamp tubes coated with a fluorescent material according to an embodiment of the present invention, on a chroma graph defined by CIE (Commission Internationale de l'Eclairage);

FIG. 7 is a table showing a comparison in various characteristics between the fluorescent lamp tubes coated with the conventional fluorescent material and the fluorescent lamp tubes coated with the fluorescent material adopted in an embodiment of the present invention;

FIG. 8 is a graph comparing spectra of white light emitted from the fluorescent lamp tubes coated with the conventional fluorescent material and spectra of white light emitted from the fluorescent lamp tubes coated with the fluorescent material adopted in an embodiment of the present invention;

FIG. 9 is a cross-sectional view of a transmissive liquid crystal display panel according to an embodiment of the present invention;

FIG. 10 is a graph showing relationships in luminance, corresponding to the distance between a diffusion plate and fluorescent lamp tubes;

FIG. 11 is a graph showing luminance ratio between over-tube luminance and inter-tube luminance;

FIG. 12 is a graph showing a relationship between the inner diameter Ø of the fluorescent lamp tubes and the luminance of the fluorescent lamp tubes; and

FIG. 13 is a table showing a relationship between the inner diameter Ø of the fluorescent lamp tubes, the lifetime of the fluorescent lamp tubes, and the luminance of the fluorescent lamp tubes.

### DETAILED DESCRIPTION

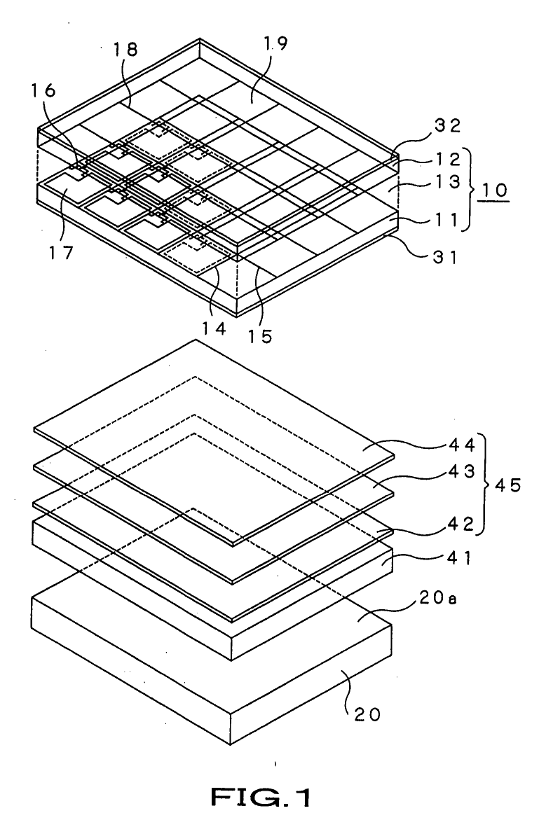

A transmissive liquid crystal display panel 1 according to an embodiment will now be described with reference to the drawings. The transmissive liquid crystal display panel 1 is used, for example, as a display panel in a television receiver. As shown in FIG. 1, the transmissive liquid crystal display panel 1 has a transmissive color liquid crystal display panel 10, and a backlight box 4 provided in the back side of the transmissive color liquid crystal display panel 10.

The transmissive color liquid crystal display panel 10 has a structure in which two transparent substrates (e.g., a TFT substrate 11 and an opposing electrode substrate 12) made of glass or the like are opposed to each other. In a gap between these substrates, for example, a liquid crystal layer 13 in which twisted nematic (TN) liquid crystal is sealed is provided. Formed on the TFT substrate 11 are signal lines 14, scanning lines 15, thin film transistors 16, and pixel electrode 17. The signal lines 14 and scanning lines 15 are arranged like a matrix. The thin film transistors 16 are provided as switching elements respectively at intersections between the signal lines 14 and the scanning lines 15. The thin film transistors 16 are selected sequentially by the scanning lines 15, and write video signals supplied through the signal lines 14, into corresponding pixel electrodes 17. On the other side, an opposing electrode 18 and a color filter 19 are formed on the inner surface of the opposing electrode substrate 12.

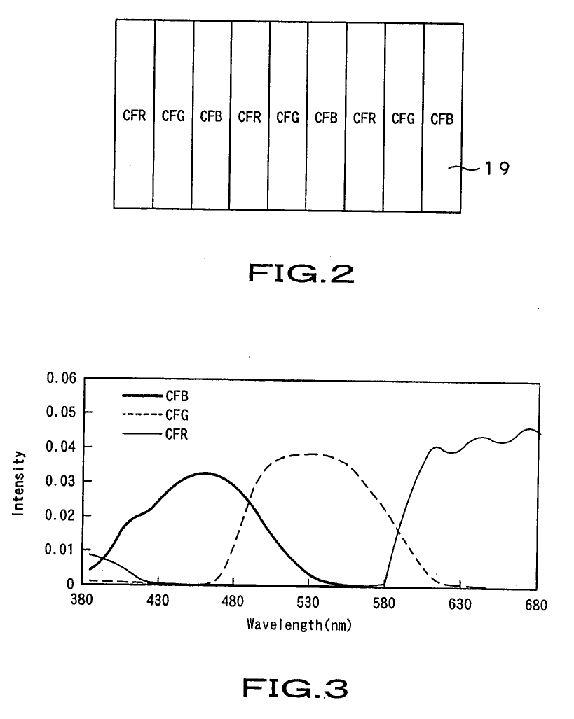

The color filter 19 is described next. The color filter 19 is divided into plural segments respectively corresponding to pixels. For example, as shown in FIG. 2, the color filter 19 is divided into three segments of a red filter CFR, a green filter CFG, and a blue filter CFB for three primary colors. As an array pattern of the color filter, there can be a delta array, a square array, or the like, in addition to a stripe array as shown in FIG. 2. The color filter 19 has predetermined spectral characteristics as shown in FIG. 3.

In the transmissive liquid crystal display panel 1, the transmissive color liquid crystal display panel 10 having the structure as described above is sandwiched between two polarizing plates 31 and 32. With white light radiated from the back side by the backlight box 40, the transmissive liquid crystal display panel 1 is driven according to an active matrix system, thereby to display a desired full-color video image.

The backlight box 40 illuminates the transmissive color liquid crystal display panel 10 by plane light emission from the back side. As shown in FIG. 1, the backlight box 40 has a box part 20 provided with an opening part 20a to radiate outwards light emitted from fluorescent lamp tubes described later, and a diffusion plate 41 above the opening part 20a of the box part 20.

The diffusion plate 41 diffuses light emitted from the opening part 20a, to obtain uniformed white light by color mixture so as not to cause unevenness in luminance and color in plane light emission. Above the diffusion plate 41, a group 45 of optical sheets including a diffusion sheet 42, a prism sheet 43, and a polarization transformation sheet 44 are stacked. The optical sheet group 43 works to raise luminance in plane light emission by directing the while light emitted from the diffusion plate 41, in the normal direction of the diffusion plate 41.

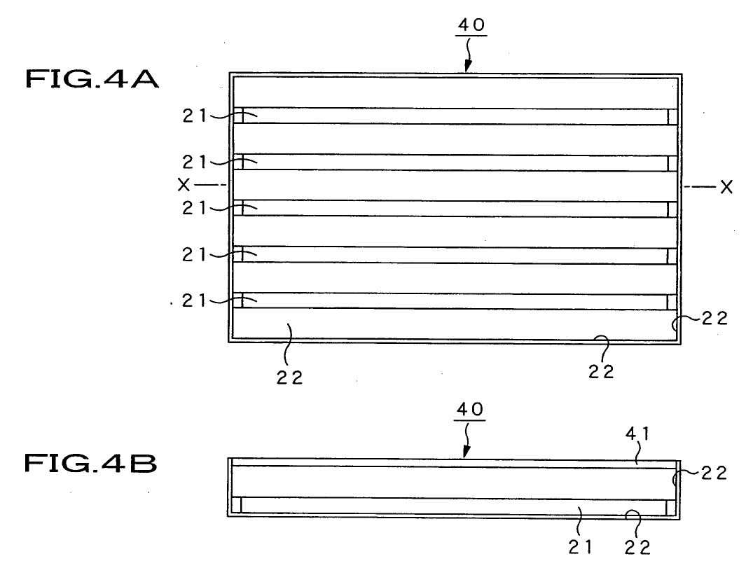

Next, a schematic structure of the box part 20 will be described with reference to FIGS. 4A and 4B. The box part 20 is a backlight device using fluorescent lamp tubes 21 as light sources. FIG. 4A is a front view of the box part 20. FIG. 4B is a cross-sectional view wherein the box part 20 is cut along the line XX shown in FIG. 4A. The diffusion plate 41 shown in FIG. 4B is omitted from FIG. 4A in order to show the layout state of the fluorescent lamp tubes 21.

The box part 20 has plural fluorescent lamp tubes 21 provided in parallel with each other in a housing as shown in FIGS. 4A and 4B. Reflection faces 22 which internally scatter and reflect the white light emitted from the fluorescent lamp tubes 21 are formed on the inner surfaces of the housing (e.g., side inner surfaces and an inner bottom surface).

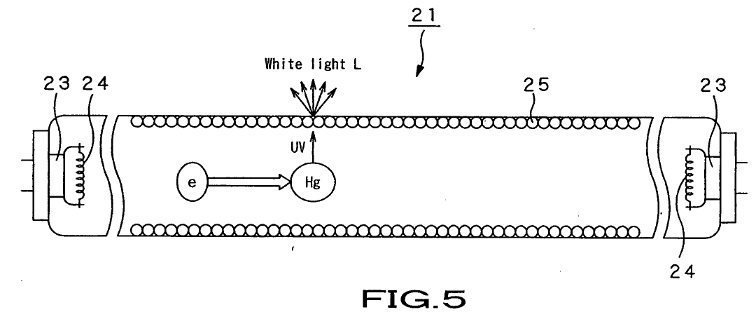

The fluorescent lamp tubes 21 will be described next. As shown in FIG. 5, the fluorescent lamp tube 21 is a cold cathode fluorescent lamp (CCFL). Electrodes are formed on both sides of the fluorescent lamp tube 21, and a predetermined fluorescent material is coated on the inner wall. Noble gases such as Hg (mercury) and Xe (xenon) are sealed in the lamp tube. Principles of light emission of the fluorescent lamp tube 21 are as follows. When a current is let flow through electrodes 23, thermal electrons e are discharged into the tube from filaments 24, starting electrically discharging. The thermal electrons e coincide with Hg atoms in the tube and are excited thereby, radiating ultraviolet rays UV. Hg atoms go to a ground state as Hg atoms radiate the ultraviolet rays UV. A fluorescent material 25 coated on the tube wall is illuminated with the ultraviolet rays UV. The ultraviolet rays are absorbed by the fluorescent material 25, and white light L is emitted to the outside. The fluorescent material 25 is supposed to consist of BaMgAl₁₀O₁₇:Eu used as a blue light emission material, BaMgAl₁₀O₁₇:Eu,Mn used as a green light emission material, and YVO₄:Eu used as a red light emission material.

Meanwhile, an object of an embodiment of the present invention is to realize widening of the color range without substantially reducing the luminance value, as previously described.

Widening of the color range depends on wavelengths of the fluorescent materials of respective colors used in the fluorescent lamp tubes 21. Although the color range can be widened by selecting such appropriate materials for the fluorescent materials that realize widening of the color range, there is a problem that the luminance is reduced. Hence, embodiments of the present invention realize a widened color range, maintain high luminance, simultaneously thinning the device, by selecting appropriate fluorescent materials which realize widening of the color range, by setting the diffusion plate 41 closer to the fluorescent lamp tubes 21, and by reducing the inner diameter Ø of the fluorescent lamp tubes 21.

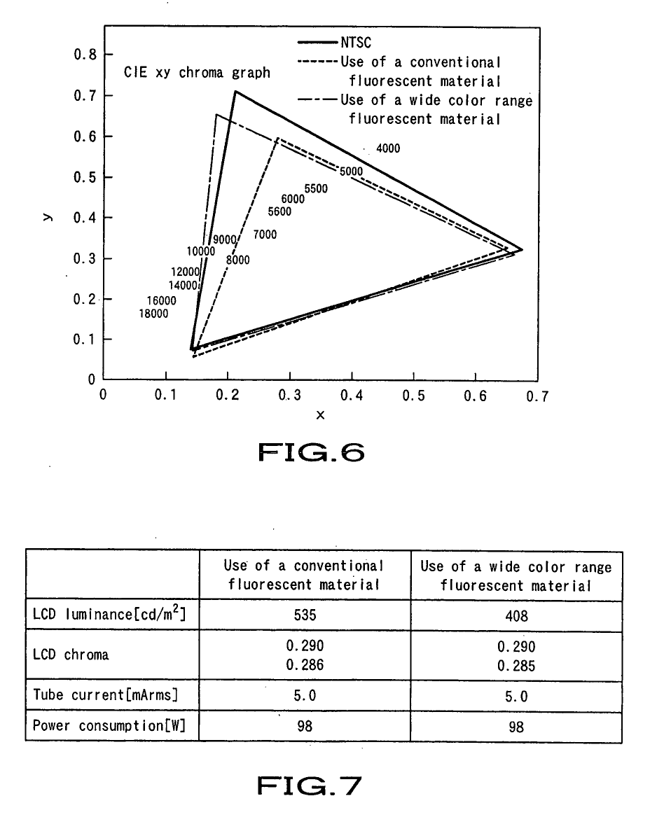

Widening of the color range by selection of fluorescent materials will now be described. FIG. 6 is an xy chroma graph of the XYZ color system defined by CIE. As can be seen from FIG. 6, in case where a conventional fluorescent material (for example, consisting of BaMgAl₁₀O₁₇:Eu as a blue light emission material, LaPO₄:Tb as a green light emission material, and Y₂O₃:Eu as a red light emission material) is coated on the inner wall, the color-reproduction range is narrower (by about 74.5%) than the other color-reproduction range defined by the standard according to the NTSC (National Television System Committee) which is adopted in a color television broadcasting system. On the other side, in case where the fluorescent material 25 adopted in the present invention is coated on the inner wall, the color reproduction range reaches a competitive level (about 93.1% of the NTSC system) compared with the NTSC system.

FIG. 7 shows a comparison in LCD luminance, LCD chroma, tube current, and power consumption between fluorescent lamp tubes 21 coated with a conventional fluorescent material and other fluorescent lamp tubes 21 coated with the fluorescent material 25 adopted in the present invention. As is apparent from FIG. 7, both materials have resulted in substantially even LCD chroma, tube current, and power consumption. However, the LCD luminance has deteriorated by 24% in the case of the latter material. A later description will be made of a countermeasure against the deterioration in the LCD luminance.

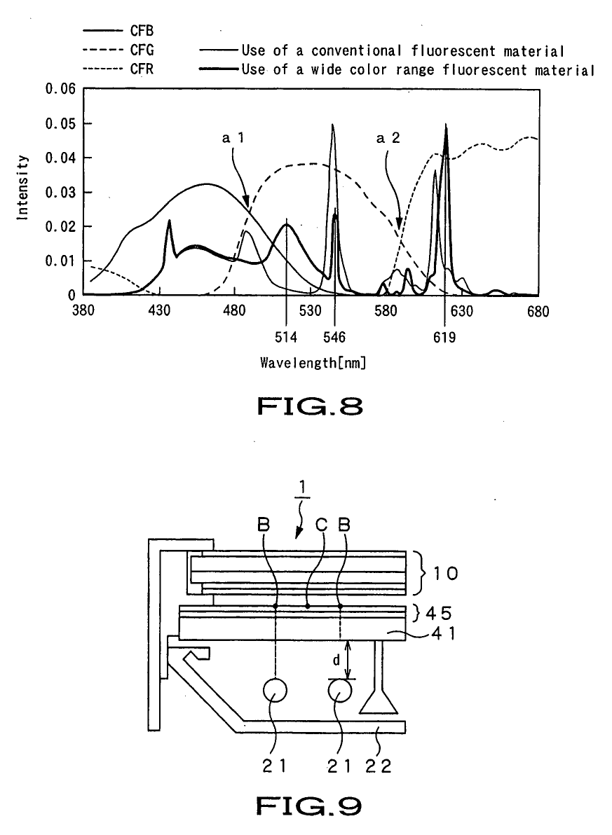

FIG. 8 shows a comparison between spectra of white light emitted from the fluorescent lamp tubes coated with the conventional fluorescent material and spectra of white light emitted from the fluorescent lamp tubes 21 coated with the fluorescent material 25 adopted in the present invention. FIG. 8 also shows spectral characteristics of the color filter 19 shown in FIG. 3.

According to the fluorescent material 25 in an embodiment, green peak wavelengths can range from about 514 nm to about 546 nm, and a red peak wavelength can be about 619 nm. In case of the fluorescent lamp tubes coated with the conventional fluorescent material, a green peak wavelength is included near a cross point a1 between curves of a blue filter CFB and a green filter CFG, resulting in a characteristic of low color purity. However, in the case of the fluorescent lamp tubes 21 coated with the fluorescent material 25 according to an embodiment, no green peak wavelength exists near the cross point a1, thus resulting in a characteristic of improved color purity.

Sensitivity of human eyes to light varies depending on the wavelength of light and peaks at around 555 nm. As the wavelength shifts to a longer wavelength side or a short wavelength side, the sensitivity decreases.

In an embodiment described below, the LCD luminance of the fluorescent lamp tubes 21 coated with the fluorescent material 25 is substantially equal to the LCD luminance of the fluorescent lamp tubes 21 coated with the conventional fluorescent material, that is, the luminance is high.

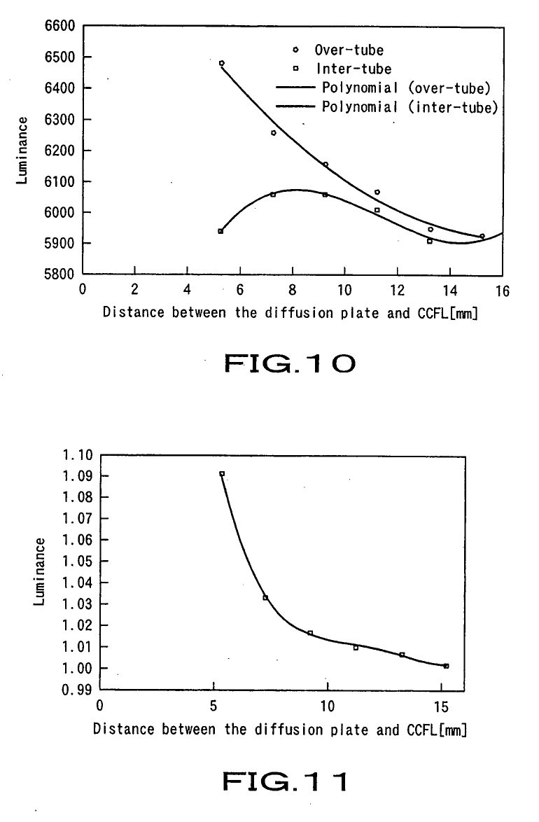

FIG. 9 is a cross-sectional view of the transmissive liquid crystal display panel 1. FIG. 10 also shows a relationship between luminance at a position B immediately above the fluorescent lamp tubes 21 (hereinafter referred to as over-tube luminance) and luminance at an intermediate position C between adjacent ones of the fluorescent lamp tubes 21 (hereinafter referred to as inter-tube luminance). As can be seen from FIG. 10, the over-tube luminance is a monotonic function, and the inter-tube luminance is a function having a maximum peak at a particular distance. FIG. 11 further shows luminance ratio between the over-tube luminance and the inter-tube luminance. A critical point where no visual irregularity in luminance occurs exists at a position where the luminance ratio is slightly below 1.01. Therefore, the critical point is found from FIG. 11 to be at a distance of about 13 mm. Accordingly, the optimum distance d between the fluorescent lamp tubes 21 and the diffusion plate 41 is about 13 mm.

Further, the optimum distance d can be further reduced by printing a dot pattern on the diffusion plate 41 by dot printing. The diffusion plate 41 and the dot printing according to an embodiment will now be described below. The diffusion plate 41 is a lactescent plate having a predetermined plate thickness (e.g., a haze value of 90 to 99% and a film thickness of about 2 mm), and diffuses incidental light. More specifically, light entering into the diffusion plate 41 causes moire forming lamp images, depending on the positions of the fluorescent lamp tubes 21. However, a dot pattern for modulating light is printed on the front or back surface of the diffusion plate 41 by an ink having a desired characteristic. Therefore, moire forming lamp images does not appear thereon.

The light-modulation dot pattern printed on the diffusion plate 41 reflects incidental light by reflectivity of the ink. Also, the light-modulation dot pattern efficiently diffuses and reflects incidental light by a light-shielding property of a light-shielding material added to the ink and by diffusivity of a diffusion material. On the other portions of the diffusion plate 41 where the light-modulation dot pattern is not printed, incidental light is not reflected but is guided into the diffusion plate 41. At this time, light entering into the diffusion plate 41 is internally diffused inside the diffusion plate 41. The diffusion plate 41 on which this light-modulation dot pattern is printed suppresses lamp images which cause problems when light emitted from linear light sources is subjected to plane light emission. Thus, luminance over the whole plane can be uniformed. Details of the light-modulation dot pattern is described in Japanese Patent Application No. 2004-238853, filed previously by the present applicant.

As described above, a predetermined dot pattern which becomes gradually thinner from the over-tube position B to the inter-tube position C is printed on the diffusion plate 41. The optimum distance d between the fluorescent lamp tubes 21 and the diffusion plate 41 can thereby be set to about 7 mm. Accordingly, the whole transmissive liquid crystal display panel 1 can be thinned while reducing irregularity in luminance of the fluorescent lamp tubes 21. The dot printing adopts a method in which the luminance at the over-tube position B is reduced to match with the luminance of another inter-tube position C, thereby to eliminate irregularity in luminance.

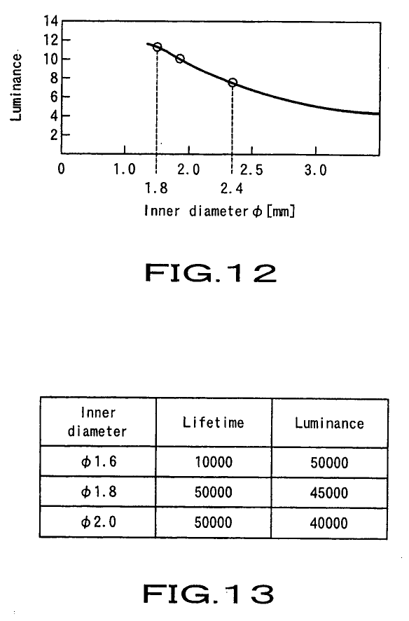

There is another method of maintaining the LCD luminance to be high, by downsizing the inner diameter Ø of the fluorescent lamp tubes 21. FIG. 12 shows a relationship between the inner diameter Ø and the luminance. As can be seen from FIG. 12, the luminance increases as the inner diameter Ø is downsized. However, there is a problem that the lifetime is shortened as the inner diameter Ø is downsized (FIG. 13). Therefore, according to the present invention, the inner diameter Ø is set to about 1.8 mm in consideration of the luminance and the lifetime. By setting the inner diameter Ø to about 1.8 mm, the efficiency is improved by about 10 to about 30%.

The transmissive liquid crystal display panel 1 constructed as described above has the backlight box 40 constituted by the fluorescent lamp tubes 21 and the diffusion plate 41. The fluorescent lamp tubes 21 has tube walls coated with a fluorescent material for a wide color range. The diffusion plate 41 is positioned at a predetermined distance from the fluorescent lamp tubes 21. By the backlight box 40, the transmissive color liquid crystal display panel 10 which displays predetermined video images by liquid crystal molecules is illuminated with white light from the back side of the panel 10. Therefore, the color range can be widened. In addition, the distance between the fluorescent lamp tubes 21 and the diffusion plate 41 is set to about 13 mm. As a result, high luminance can be maintained without causing irregularity in luminance. Further, the distance between the fluorescent lamp tubes 21 and the diffusion plate 41 can be reduced to about 7 mm, by printing a predetermined dot pattern on the diffusion plate 41, so that the tubes 21 and the plate 41 can be closer to each other. Thus, the transmissive liquid crystal display panel 1 can be thinned. Alternatively, high luminance can be maintained by downsizing the inner diameter Ø of the fluorescent lamp tubes 21 (to Ø=1.8 mm).

It should be understood by those skilled in the art that various modifications, combinations, sub-combinations and alterations may occur depending on design requirements and other factors insofar as they are within the scope of the appended claims or the equivalents thereof.

The invention is claimed as follows:

1. A backlight device which illuminates a transmissive color liquid crystal display panel with white light from a back side of the transmissive color liquid crystal display panel having a three-primary-color filter which selectively transmits light having wavelengths of red light, green light, and blue light, said backlight device comprising:
a plurality of cold cathode fluorescent lamp tubes having tube walls coated with a wide-color-range fluorescent material; and
diffusion plate which diffuses white light emitted from the cold cathode fluorescent lamp tubes, illuminates the color liquid crystal display panel with said diffused white light, and is positioned at a predetermined distance from the cold cathode fluorescent lamp tubes,
wherein a predetermined pattern is printed on the diffusion plate by dot printing, corresponding to positions at which the cold cathode fluorescent lamp tubes are provided, and wherein the diffusion plate is positioned several mm apart from the cold cathode fluorescent lamp tubes.

2. The backlight device according to claim 1, wherein the tube walls of the cold cathode fluorescent lamp tubes are coated with BaMgAl₁₀O₁₇:Eu as a blue fluorescent material, BaMgAl₁₀O₁₇:Eu,Mn as a green fluorescent material, and YVO₄:Eu as a red fluorescent material.

3. A backlight device which illuminates a transmissive color liquid crystal display panel with white light from a back side of the transmissive color liquid crystal display panel having a three-primary-color filter which selectively transmits light having wavelengths of red light, green light, and blue light, the backlight device comprising:
a plurality of cold cathode fluorescent lamp tubes having tube walls coated with a wide-color-range fluorescent material; and
a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes,
wherein the cold cathode fluorescent lamp tubes have an inner diameter which is based on a lifetime of the cold cathode fluorescent lamp tubes, and on a luminance of the white light emitted from the cold cathode fluorescent lamp tubes.

4. The backlight device according to claim 3, wherein the tube walls of the cold cathode fluorescent lamp tubes are coated with BaMgAl₁₀O₁₇:Eu as a blue fluorescent material, BaMgAl₁₀O₁₇:Eu,Mn as a green fluorescent material, and YVO₄:Eu as a red fluorescent material.

5. The backlight device according to claim 3, wherein the inner diameter of the cold cathode fluorescent lamp tubes is about 1.8 mm.

6. A liquid crystal display device having a backlight device which illuminates a transmissive color liquid crystal display panel with white light from a back side of the transmissive color liquid crystal display panel having a three-primary-color filter which selectively transmits light having wavelengths of red light, green light, and blue light, the backlight device comprising:
a plurality of cold cathode fluorescent lamp tubes having tube walls coated with a wide-color-range fluorescent material; and
a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes,
wherein a predetermined pattern is printed on the diffusion plate by dot printing, corresponding to positions at which the cold cathode fluorescent lamp tubes are provided, and wherein the diffusion plate is positioned several mm apart from the cold cathode fluorescent lamp tubes.

7. The liquid crystal display device according to claim 6, wherein the tube walls of the cold cathode fluorescent lamp tubes are coated with BaMgAl₁₀O₁₇:Eu as a blue fluorescent material, BaMgAl₁₀O₁₇:Eu,Mn as a green fluorescent material, and YVO₄:Eu as a red fluorescent material.

8. A liquid crystal display device having a backlight device which illuminates a transmissive color liquid crystal display panel with white light from a back side of the transmissive color liquid crystal display panel having a three-primary-color filter which selectively transmits light having wavelengths of red light, green light, and blue light, the backlight device comprising:
a plurality of cold cathode fluorescent lamp tubes having tube walls coated with a wide-color-range fluorescent material; and
a diffusion plate which diffuses white light emitted from the cold cathode fluorescent lamp tubes, illuminates the color liquid crystal display panel with the diffused white light, and is positioned at a predetermined distance from the cold cathode fluorescent lamp tubes,
wherein the cold cathode fluorescent lamp tubes have an inner diameter which is based on a lifetime of the cold cathode fluorescent lamp tubes, and on a luminance of the white light emitted from the cold cathode fluorescent lamp tubes.

9. The liquid crystal display device according to claim 8, wherein the tube walls of the cold cathode fluorescent lamp tubes are coated with BaMgA₁₀O₁₇:Eu as a blue fluorescent material, BaMgAl₁₀O₁₇:Eu,Mn as a green fluorescent material, and YVO₄:Eu as a red fluorescent material.

10. The liquid crystal display device according to claim 8, wherein the inner diameter of the cold cathode fluorescent lamp tubes is about 1.8 mm.
